(19) United States
(12) Patent Application Publication
(10) Pub. No.: US 2007/0064579 A1
(43) Pub. Date: Mar. 22, 2007

(54) Recordable DVD structure

(75) Inventor: Joseph J. Wrobel, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/229,275

(22) Filed: Sep. 16, 2005

(51) Int. Cl. G11B 7/24

(52) U.S. Cl. 369/275.3

(57) ABSTRACT

A structure of a recordable DVD disc is disclosed that permits a second session to be recorded and accessed by DVD players that do not recognize multisession media and utilize the ISO 9660 file structure by modifying the value of the Location of Extent within the Directory Record of the VIDEO_TS directory located in the ISO 9660 Root directory of the first session to refer to an extent outside the first session.

### CROSS REFERENCE TO RELATED APPLICATIONS

Reference is made to commonly assigned U.S. patent application Ser. No. 11/173,699 filed Jul. 1, 2005, entitled “Recordable DVD Structure” by Joseph J. Wrobel and U.S. Patent Application Serial No. ,entitled “Recordable DVD Structure” by Joseph J. Wrobel, the disclosures of which are incorporated herein by reference.

### FIELD OF THE INVENTION

The present invention relates to optical recording discs and, more particularly, to an improved recordable Digital Versatile Disc (DVD) format disc structure.

### BACKGROUND OF THE INVENTION

Recordable DVD format discs are well known in the art. Physical standards for the DVD-R type recordable DVD format disc are available from the DVD Format/Logo Licensing Corporation. Physical standards for the DVD+R type recordable DVD format disc are available from the Intellectual Property & Standards group of the Philips Corporation.

In addition there are logical standards for the arrangement of data on the discs. The file structure on DVD media is typically compliant with the Universal Data Format (UDF) Specification defined and maintained by the Optical Storage Technology Association (OSTA). The UDF specification is a specific embodiment of the ISO/IEC 13346 standard (and the equivalent publication ECMA-167) entitled “Volume and File Structure of Write-Once and Rewritable Media using Non-Sequential Recording for Information Interchange”. UDF 1.02 requires that all DVD-Video discs shall be mastered to contain all required data as specified by ISO 13346 and UDF.

In practice, most DVD media also incorporate the file structure specified by the International Standards Organization (ISO) 9660 standard (“Information processing—Volume and file structure of CD-ROM for information interchange”). If a disc contains both UDF and ISO 9660 file systems, then it is known as a UDF Bridge disc. Although the UDF version 2.50 document states that consumer DVD players shall only support UDF, some consumer players utilize the ISO 9660 file structure and ignore the UDF file structure.

The UDF standard applies to both forms of DVD media, ROM and recordable. The most recent version supports multisession recording. Multisession recording is important for write-once media such as DVD-R and DVD+R because it allows a user to add additional information to the disc over time. If a new session is written to a disc in accordance with the appropriate specifications, then a multisession capable player will be able to read all of the information recorded to the disc in all of the sessions.

Multisession recording is beneficial because given the substantial capacity of the DVD format, it is often the case that a disc is written well short of its capacity, and a user would benefit by adding more information at a later time. Multisession recording also finds use in applications in which a first session is recorded with generic content, for example software, and a second session is added with user specific data. An example of such a disc would be an imaging application in which the first session contained image display software and the second session contained images belonging to the end user. The recordable DVD disc bearing the first session software could be sold to the public who could then add their images in a second session to be viewed using the software in the first session.

A multisession disc is closed to further append when a new session is written to the disc with the stipulation that it be the last session. This last session could contain new content or it could be a “dummy” session, i.e. session with no new content. In any case, the disc is finalized, i.e. put in a condition that allows no further additional sessions.

Unfortunately, although there are benefits to multisession DVD discs, the majority of the installed base of consumer DVD players are not multisession capable. They are produced to meet version 1.02 of the UDF specification that was issued before the process for multisession recording was defined in that specification. If a multisession disc is placed into a player that is not multisession capable, the player will only allow access to information stored in the first session; any subsequent information added to the disc is unknown to the player and will be inaccessible to the user.

The inability for a large portion of the installed base of DVD players to recognize and correctly access all the information on a multisession DVD disc limits the utility of applications that rely on multisession recording.

### SUMMARY OF THE INVENTION

It is therefore an object of the present invention to provide a structure of a recordable DVD disc that permits a second session to be recorded and accessed by DVD video players that do not recognize multisession media and utilize the ISO 9660 file structure.

It is a further object of the present invention to provide a recordable DVD disc structure that is particularly beneficial for applications in which the first session is generic for many users and the second session is customized to an individual user.

This object is achieved by a recordable DVD disc, comprising:
a) a recorded first session; and
b) a value of the Location of Extent within the Directory Record of the VIDEO_TS directory located in the ISO 9660 Root directory of the first session that refers to an extent outside the first session.

The UDF specification for multisession recordable DVD discs defines a structure that limits access of a player that is not multisession capable to the first session on the disc. The present invention provides a structure that enables a player that is not multisession capable and utilizes the ISO 9660 file structure to access DVD video information recorded in the second session of a two session recordable DVD disc.

### BRIEF DESCRIPTION OF THE DRAWINGS

FIG. 1 is a diagram of a DVD recordable disc bearing a first session;

FIG. 2 is a diagram of a DVD recordable disc bearing a first session and a second session; and

FIG. 3 is a flow chart of a segment of a DVD player's operation.

### DETAILED DESCRIPTION OF THE INVENTION

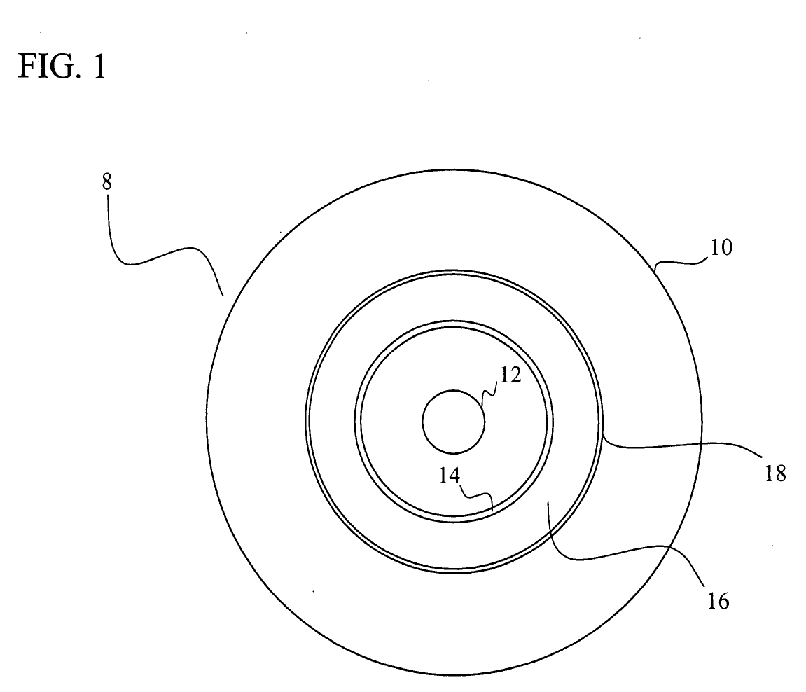

A recordable DVD disc 8 holds data in a physical area called a session. Each session is comprised of three zones: a lead-in zone, a data zone and a lead-out zone. The disc 8 with a single recorded session is represented graphically in FIG. 1. Between the disc outer diameter 10 and the disc center hole 12, the disc 8 bears a single recorded session. A lead-in zone 14 of the first session is recorded at an inner diameter defined by the recordable DVD specification. Immediately following this lead-in zone 14 is a data zone 16 of the first session. The size of the data zone 16 is directly related to the amount of data stored in the first session. Immediately following this data zone 16 is a lead-out zone 18 of the first session.

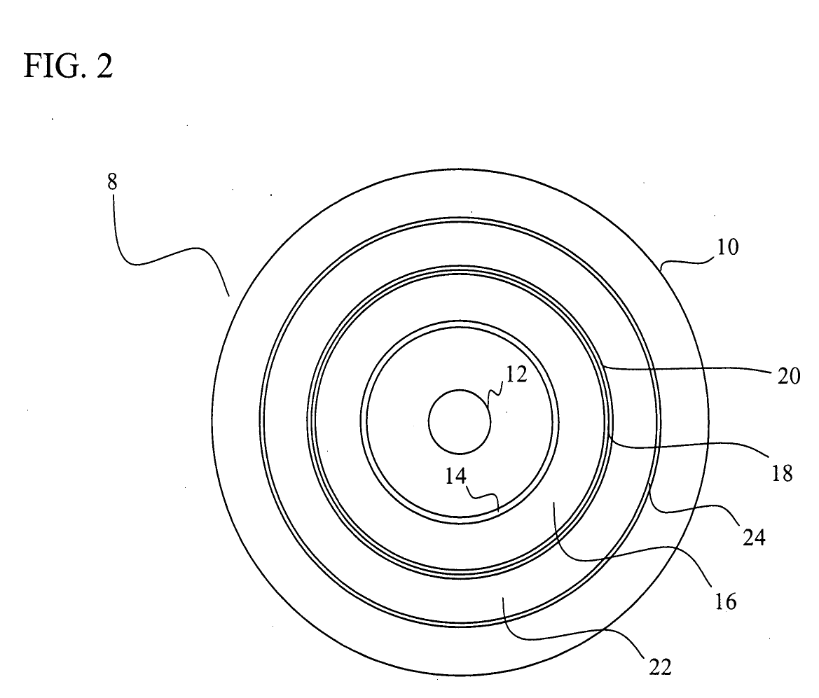

A recordable DVD disc 8 with a first recorded session and a second recorded session is represented graphically in FIG. 2. In addition to the features of a single session disc 8 shown in FIG. 1, a disc 8 with two sessions has three additional zones. A lead-in zone of the second session 20 is recorded immediately following the lead-out zone of the first session 18. Immediately following the lead-in zone of the second session 20 is a data zone 22 of the second session. The size of the data zone 22 is directly related to the amount of data stored in the second session. Immediately following this data zone 22 is a lead-out zone 24 of the second session.

The information as to whether a recorded DVD disc is single session or multisession is stored outside the data zones of the disc 8 as is well known in the disc making art. If a DVD player is multisession capable, it must read the session information before it begins to read the user data from the disc 8. The session information includes the location and length of each session on the disc 8. The DVD player needs this session information because as each new session is recorded, the structure that contains the current file and directory information is updated and recorded anew in the new session. The structure that contains file and directory information for the current content of the disc 8 is stored in the last recorded session. Once the number and location of the last session is known, the player accesses that session and begins to read information from the user data area of the session. If a DVD player is not multisession capable, then it accesses the first session regardless of the number of sessions recorded on the disc.

If a player utilizes the ISO 9660 file structure on a disc, then it follows a series of procedures to read the video DVD information on the disc. If a DVD player follows this series, then it must execute a sequence of operations that are summarized in TABLE 1. This sequence of operations occurs after the DVD player has recognized that a new DVD disc 8 has been mounted, has completed the necessary electro-mechanical operations to provide focus and tracking, and has accessed a session on the DVD disc 8.

TABLE 1

| | at Logical | | |
|---|---|---|---|
| | Sector | | |
| operation | Number (LSN) | extract | From |
| 1 | 16 | Volume Descriptor | Volume |
| | | Type and Standard | Descriptor Set |
| | | Identifier | |
| 2 | 16 | Root Directory | Directory Record |
| | | Location of Extent | for the Root |
| | | (RD LSN) | Directory within |
| | | | the Primary |
| | | | Volume Descriptor |
| 3 | RD LSN | VIDEO_TS Directory | Directory Record |
| | | Location of Extent | for the |
| | | (VT_SD LSN) | VIDEO_TS |
| | | | Directory within |
| | | | the Root Directory |
| 4 | V_TSD LSN | VIDEO_TS.IFO File | Directory Record |
| | | Location of Extent | for the |
| | | (V_TSI LSN) | VIDEO_TS.IFO |
| | | | File within the |
| | | | VIDEO_TS |
| | | | Directory |
| 5 | V_TSI LSN | DVD video content | VIDEO_TS.IFO |
| | | | file |

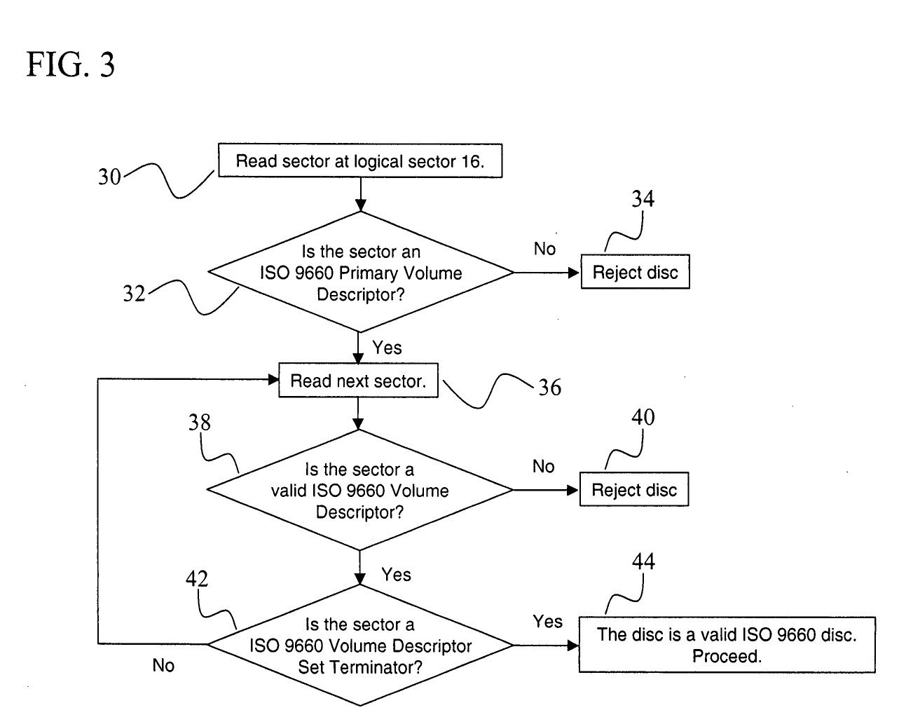

The first operation of the sequence is to determine if the disc 8 is recorded in accordance with the ISO 9660 specification. This operation is represented in FIG. 3 which is a flow chart of a segment of a DVD player's operation. In order to make the determination, the player begins by reading logical sector number 16 of disc 8 (process block 30). It then determines whether that sector constitutes a valid ISO 9660 Primary Volume Descriptor (decision block 32). If it does not, then the disc is rejected (process block 34). If it does, then the player reads the next sector (process block 36). The player then determines whether that sector is a valid ISO 9660 Volume Descriptor (decision block 38). If it is not, then the disc is rejected (process block 40). If it is, then the player determines whether it is a Volume Descriptor Set Terminator (decision block 42). If it is not, then the player loops back to read the next sector (process block 36) and repeats the subsequent process steps. If it is, then the drive accepts the disc as being in ISO 9660 format and proceeds to the next operation (process block 44).

The second operation has the purpose of locating the Root directory. The player retrieves the Root directory Location of Extent from the Directory Record for the Root directory within the Primary Volume Descriptor. The Root directory Location of Extent is the Logical Sector Number of the first Logical Sector allocated to the Extent.

The third operation has the purpose of locating the VIDEO_TS directory. The player retrieves the VIDEO_TS directory Location of Extent from the Directory Record for the VIDEO_TS directory within the Root directory. The VIDEO_TS directory Location of Extent is the Logical Sector Number of the first Logical Sector allocated to the Extent.

The fourth operation has the purpose of locating the VIDEO_TS.IFO file. The player retrieves the VIDEO_TS.IFO file Location of Extent from the Directory Record for the VIDEO_TS.IFO file within the VIDEO_TS directory. The VIDEO_TS.IFO file Location of Extent is the Logical Sector Number of the first Logical Sector allocated to the Extent.

The fifth operation has the purpose of playing the content on the disc. Once the VIDEO_TS.IFO file is located, the other files required by a DVD video player to present the DVD video information on the disc may be accessed as needed.

If a DVD player is not multisession compatible and is dealing with a single session disc, then the process described above is carried out in the first (and only) session, and all the structure needed to access the user data and directories on the disc will be correctly read. If a DVD player is not multisession compatible and is dealing with a multisession disc, then the process described above is still carried out in the first session, and the structure found will only allow access to the user data and directories in the first session. The DVD video content in subsequent sessions is inaccessible.

In order to allow all the data on a multisession disc to be available to a DVD player that is not compatible with a multisession disc, the present invention enables the player to access the last structure recorded on the disc. By altering the value of the Location of Extent within the Directory Record of the VIDEO_TS directory located in the ISO 9660 Root directory of the first session such that it refers to an extent outside the first session, a DVD player that is not compatible with a multisession disc will be led to access DVD video information stored outside the first session.

In order for the access of the DVD video information in the second session to be successful, the altered value of the Location of Extent within the Directory Record of the VIDEO_TS directory located in the ISO 9660 Root directory of the first session must direct the player to the VIDEO_TS directory in the second session. Since, in general, the first session of the disc will be written without foreknowledge of the detailed contents of the second session, the problem must be addressed in reverse. That is, the VIDEO_TS directory in the second session must be recorded at the logical sector number to which the player will be directed by the altered value of the Location of Extent within the Directory Record of the VIDEO_TS directory located in the ISO 9660 Root directory of the first session.

This may be accomplished by reading the value of the Location of Extent within the Directory Record of the VIDEO_TS directory located in the ISO 9660 Root directory of the first session prior to writing the second session and modifying the ISO 9660 structure creation software so the second session VIDEO_TS directory is appropriately positioned, but this is a rather complicated task. A simpler approach would be to run the ISO 9660 structure creation software unaltered when creating the second session, then to copy the second session VIDEO_TS directory to the logical sector number to which the player will be directed by the altered value of the Location of Extent within the Directory Record of the VIDEO_TS directory located in the ISO 9660 Root directory of the first session. This latter approach requires that the logical sector number chosen for the copy of the second session VIDEO_TS directory is unused by any other file or structure and is accessible within the second session. Fortunately, there are a number of locations that meet these requirements. For example, according to UDF 1.02, of the first 256 sectors of the second session, less than half are allocated. The remaining sectors are unallocated and not reserved. In particular, logical sector numbers 80 through 255 inclusive are not generally allocated, making this region a prime candidate for the location of a copy of the second session VIDEO_TS directory.

A general method for creating a two session recordable DVD video disc that is compatible with DVD video players that do not recognize multisession DVD media and utilize the ISO 9660 file structure is outlined below.

1) Prepare a binary image of a first session for recording on a recordable DVD disc including both binary data and a file system compatible with the Universal Disk Format Specification. (A binary image contains the actual data that should exist on the DVD disc.) Alternatively the first session can be recorded in standard fashion and subsequently the binary image generated by reading the first session from the disc as a binary image.

2) Based on the size of the binary image of the first session, compute what the starting sector of the second session would be if the first session were recorded in a mode compatible with multisession recording. Alternatively, a second session can be recorded after the first session, and the starting sector of the second session read from the disc using appropriate software tools.

3) Modify the binary image of the first session by changing the value of the Location of Extent within the Directory Record of the VIDEO_TS directory located in the ISO 9660 Root directory of the first session. The value of the Location of Extent must refer to an extent outside the first session. If the location that the VIDEO_TS directory will occupy in the second session is known, then the value of the Location of Extent within the Directory Record of the VIDEO_TS directory located in the ISO 9660 Root directory of the first session is set to this location. If the location that the VIDEO_TS directory will occupy in the second session is not known, then the value of the Location of Extent within the Directory Record of the VIDEO_TS directory located in the ISO 9660 Root directory of the first session is set to a location in the second session that is unallocated and can be used by the second session authoring software to locate a copy of the second session VIDEO_TS directory. In the latter case, a preferred location would be within the first 256 logical sectors of the second session and preferably between logical sector numbers 80 and 255 inclusive.

4) Record the modified binary image of the first session in a mode compatible with multisession recording.

5) Use authoring software for creating the second session that reads the value of the Location of Extent within the Directory Record of the VIDEO_TS directory located in the ISO 9660 Root directory of the first session and creates a copy of the second session VIDEO_TS directory at that location in the binary image of the second session.

6) Record the second session.

When a disc created as outlined above is played by a DVD player that does not recognize multisession DVD media, the player will attempt to locate the VIDEO_TS directory by reading the value of the Location of Extent within the Directory Record of the VIDEO_TS directory located in the ISO 9660 Root directory of the first session. This value will lead the player to the location of the copy of the second session VIDEO_TS directory, and then on to the DVD video information stored within the second session.

The invention has been described in detail with particular reference to certain preferred embodiments thereof, but it will be understood that variations and modifications can be effected within the spirit and scope of the invention.

### Parts List

8 disc
10 disc outer diameter
12 disc centering hole
14 first session lead-in zone
16 first session data zone
18 first session lead-out zone
20 second session lead-in zone
22 second session data zone
24 second session lead-out zone
30 process block
32 decision block
34 process block
36 process block
38 decision block
40 process block
42 decision block
44 process block

1. A recordable DVD disc, comprising:
a) a recorded first session; and
b) an ISO 9660 Root directory in the first session containing a Directory Record for a VIDEO_TS directory with a Location of Extent having a value that refers to an extent outside the first session.

2. The recordable DVD disc of claim 1 wherein the value of the Location of Extent within the Directory Record of the VIDEO_TS directory located in the ISO 9660 Root directory of the first session refers to an extent located within the first 256 logical sectors of a second session.

3. The recordable DVD disc of claim 2 wherein the value of the Location of Extent within the Directory Record of the VIDEO_TS directory located in the ISO 9660 Root directory of the first session refers to an extent located within logical sector numbers 80 through 255 inclusive of the second session.
